(19) United States
(12) Patent Application Publication
(10) Pub. No.: US 2022/0001586 A1
(43) Pub. Date: Jan. 6, 2022

(54) METHOD AND SYSTEM FOR IMPROVING A PHYSICAL PRODUCTION PROCESS

(71) Applicant: COVESTRO INTELLECTUAL PROPERTY GMBH & CO. KG, Leverkursen (DE)

(72) Inventors: Olaf ZÖLLNER, Leverkusen (DE); Sebastian ZOPPE, Köln (DE); Sairam POTARAJU, Leverkusen (DE); Rainer PROTTE, Dormagen (DE); Christoph BONTENACKELS, Köln (DE)

(21) Appl. No.: 17/294,581

(22) PCT Filed: Nov. 14, 2019
(86) PCT No.: PCT/EP2019/081315

§ 371 Date: May 17, 2021

(30) Foreign Application Priority Data
Nov. 16, 2018 (EP) 18206788.4

(51) Int. Cl. B29C 45/76

(52) U.S. Cl. CPC B29C 45/76; B29C 2945/76939; B29C 2945/76461

(57) ABSTRACT

The invention relates to a method and system wherein an analysis system (6) measures derivative process parameters (7) from the derivative physical production process, wherein the precursor charge (3) is produced at a precursor production facility (8) at least 50 km distant from the physical production facility (2) through a precursor production process based on applied precursor production settings (9), wherein the precursor charge (3) is transported to the physical production facility (2), wherein the analysis system (6) measures precursor process parameters (11) from the precursor production process and precursor product parameters (12) from the precursor charge (3), wherein the analysis system (6) enters the applied derivative process settings (4), the measured derivative process parameters (7), the applied precursor production settings (9), the measured precursor process parameters (11), the measured precursor product parameters (12) as input to a process model (13), which process model (13) describes a computational relationship between derivative process settings, derivative process parameters, precursor production settings, precursor process parameters and precursor product parameters, to obtain updated derivative process settings (15).

The invention is directed at a method for improving a physical production process and at a system for improving a physical production process.

Production processes and in particular physical production processes are complex. This includes injection molding processes. The results of the physical production processes are dependent on a very large number of variables and parameters. It is regularly the case that not only a large portion of these variables and parameters is not measured, either because their relevance is not recognized or measurement would be too difficult, but also that their effect on the product is not known. Sometimes there is no theoretical groundwork for stipulating such a dependency. Sometimes even when a dependency is suspected, there is insufficient data to determine such a dependency quantitatively with sufficient accuracy. Yet recognizing and acting on such dependencies would be an important step in coming closer to desired properties of the final product and in reducing the proportion of defective products. This aspect becomes even more important when a physical product is produced in separate steps which may also be undertaken at different facilities which are distant from each other. For example, parameters in the production process of a precursor, for example a polymer, may be relevant for properties of a final product made from the precursor in a physical production process such as injection molding.

Advances in sensor and in particular computing technology have made it possible to not only accumulate very large amounts of data in real-time, but also to numerically process very large amounts of data within reasonable time and at reasonable costs. Thus, it has become possible to monitor physical production processes and to detect any anomalies in an early production step within a plant, which makes it possible to either identify batches that are likely to result in a defective product or to make it timely adjustments to process settings in order to prevent defects from occurring in that batch. However, such close monitoring has been restricted to individual sites and facilities.

United States Patent Application Publication US 2002/0031567 A1 discloses a control system for a molding machine which includes a control unit having a communication function to connect the control unit with a portable data terminal such as a mobile phone through the Internet so that operation of the molding machine can be controlled based on instructions given from remote locations via the mobile phone.

International Patent Application WO 01/41994 A1, which is considered the closest prior art, discloses an apparatus for optimizing a rubber manufacturing process having multiple process steps, wherein the process steps can be adjusted during the manufacturing process to achieve a desired rubber product, the method including obtaining a rubber material sample during the manufacturing process, analyzing the rubber material sample to generate processability data, comparing the generated processability data with known processability data that is stored in a central database, determining any process adjustments required to achieve optimal processability of the rubber material sample and a mechanism for implementing the process adjustments during the rubber manufacturing process to achieve a desired rubber product.

Therefore the object of the invention is to provide a method and a system for improving a physical production process which takes account of the fact that a physical production facility will also rely on precursor material provided by distant precursor production facility.

With respect to a method for improving a physical production process the object of the invention is achieved through a method for improving a physical production process according to claim 1. With respect to a system for improving a physical production process the object of the invention is achieved through a system for improving a physical production process according to claim 15.

The invention is based on the recognition that a monitoring of process variables need not be restricted to an individual physical production facility or to a number of physical production facilities that operate in parallel, i.e. at substantially the same stage in terms of production. Instead, it has been found advantageous to extend the monitoring of process variables to a precursor production facility that provides the precursor material for the downstream physical production facility. In that way, the production process as whole can be monitored, thereby improving accuracy and comprehensiveness.

The method according to the invention is for improving a physical production process. In the method according to the invention, a derivative physical product is produced at a physical production facility through a derivative physical production process from a precursor charge of precursor material based on applied derivative process settings. Any production process involving a physical reaction may be understood to present a physical production process. The expression “derivative physical product” and “derivative physical production process” only signifies that there is at least one precursor charge of precursor material used in the derivative physical production process, which shall be described in more detail below. The derivative process settings are process parameters that are input in any sense to the derivative physical production process and comprise e.g. machine settings. In other words, they may be set differently for a different precursor charge. It is to be noted that the derivative physical product may be produced based on additional material which is then combined in some way with the precursor charge. The precursor charge may provide less than half of component volume for the production of the derivative physical product.

Here and hereinafter, a physical production process is any production process which involves a physical change—or several physical changes—in the precursor charge during the physical production process. For example, any change in the state of matter of the precursor charge is such a physical change. In particular, the melting and solidification of a thermoplastic material in an injection molding process is a physical change. It follows that an injection molding process is a physical production process within the meaning of this invention. In addition, the physical production process may also comprise further changes, for example chemical or mechanical changes

In the method according to the invention, an analysis system measures derivative process parameters from the derivative physical production process. The analysis system may be any system of sensors and other devices as well as software or any combination thereof. Thus the analysis system may comprise any number of computers. The analysis system may also at least partially reside in a cloud computing environment. The derivative process parameters may be any values that can be measured or observed and that pertain to the derivative physical production process.

In the method according to the invention, the precursor charge is produced at a precursor production facility distant from the physical production facility through a precursor production process based on applied precursor production settings, wherein the precursor charge is transported to the physical production facility. In principle, the precursor production facility may be at any distance from the physical production facility. In the method according to the invention, the precursor production facility is at least 50 kilometers distant from the physical production facility. Preferably, the precursor production facility is at least 100 kilometers, at least 500 kilometers or at least 1000 kilometers distant from the physical production facility.

Moreover, in practice a precursor production process itself may also be subdivided into several precursor production process steps. Potentially, each of these precursor production steps may be performed at a respective and separate precursor production step facility, where at least some of the precursor production step facilities may also be distant from each other. Here, either all of these precursor production step facilities, one of the precursor production step facilities or some of the precursor production step facilities may be understood to be the above precursor production facility, with the corresponding precursor production steps forming the above precursor production process.

Further in the method according to the invention, the analysis system measures precursor process parameters from the precursor production process and precursor product parameters from the precursor charge. It is to be noted that the measurement of the precursor product parameters may equally occur in the physical production facility, in the precursor production facility or in some other place.

In the method according to the invention, the analysis system enters the applied derivative process settings, the measured derivative process parameters, the applied precursor production settings, the measured precursor process parameters and the measured precursor product parameters as input to a process model, which process model describes a computational relationship between derivative process settings, derivative process parameters, precursor production settings, precursor process parameters and precursor product parameters to obtain updated derivative process settings for matching user-defined derivative product specifications describing derivative product parameters, wherein the updated derivative process settings are applied to the derivative physical production process. With respect to the user-defined derivative product specifications, these are derivative product specifications which have been input in principle externally and which prescribe derivative product parameters either implicitly or explicitly. Such prescribing may relate to e.g. thresholds, specific values, specific value brackets or combinations of values and value brackets.

In other words, the process model is capable, by virtue of the computational relationship between the aforementioned quantities, to determine derivative process settings—i.e. the updated derivative process settings—which according to the process model are suitable for achieving or at least approximating the derivative product specifications when being input—i.e. applied—to the derivative physical production process. The process module may be a software module or application for providing such a computational relationship. The process model may also be a data set or a database configured to be provided to a in particular generic computation software in order to provide said computational relationship. The process model may partially or entirely reside within a cloud computing system.

In principle, the updated derivative process settings can be applied to the derivative physical production process in any way, e.g. manually. Preferably, the analysis system applies the updated derivative process settings to the derivative physical production process. In this way, the various measurements from the precursor production process can be taken into account when determining the derivative process settings to be applied to the derivative physical production process. It is to be noted that the updated derivative process settings may be based only on some of the quantities input to the process model. Moreover, the updated process settings may also rely on further data input to the process model, in particular data from a previous production of a derivative physical product.

In a preferred embodiment of the invention, the updated derivative process settings are applied to the derivative physical production process for the derivative physical product from the precursor charge. In particular, the updated derivative process settings are applied to the current derivative physical production process for the derivative product from the current precursor charge. In this way, the ongoing production of the derivative physical product can be influenced in order to avoid defects or improve quality.

Here it may also be that the analysis system enters the applied derivative process settings from the derivative physical production process for the precursor charge. This means, the input model receives derivative process settings with respect to the derivative physical production process that processes that particular precursor charge.

Also, it may be that the analysis system enters the derivative process parameters measured from the derivative physical production process for the precursor charge. Thus, the derivative process parameters are also associated with the particular precursor charge with which also the derivative process settings are associated.

In another preferred embodiment of the invention, the analysis system measures derivative product parameters from the derivative physical product, the analysis system matches the measured derivative product parameters to the user-defined derivative product specifications describing derivative product parameters and the analysis system also enters the measured derivative product parameters as input to the process model and the process model extends the computational relationship to the measured derivative product parameters. In particular, the analysis system measures derivative product parameters from the derivative physical product for the precursor charge. In this case, the production process of precursor charges subsequent to the current precursor charge may be influenced by the updated derivative process settings. In particular, the current precursor charge and the derivative product produced from it forms the basis for updated derivative process settings that can be used for a subsequent precursor charge and the derivative production process in which the subsequent precursor charge is used. The above derivative product parameters are in principle any variables measured or obtained from the derivative physical product which has been produced by the derivative physical production process from the precursor charge. In particular, the derivative product parameters may relate to the surface quality of the derivative physical product, especially the surface roughness, the surface finish or the surface contour (e.g. waviness of the surface).

According to a preferred embodiment of the invention the derivative product parameters from the derivative physical product, in particular the aforementioned derivative product parameters, are measured using optical inspection techniques. The optical inspection techniques may comprise the use of visual light which is directed to the surface of the derivative physical product for surface inspection. In particular, the surface inspection may be carried out applying a stripe light scan for detecting surface contours deviations. Also, the optical inspection may be used to determine the surface roughness or the surface finish. According to a preferable embodiment the optical inspection techniques may comprise the use of infrared (IR) light e.g. in order to analyze temperature distribution on the surface of the derivative physical product.

In particular, it may be that the analysis system measures the derivative product parameters after the derivative product has been subject to one or more further post-production processes, which post-production processes themselves may not be comprised by the physical production process. Such post-production processes may comprise aftertreatment such as coloring and surface coating. The reason for this may be that some derivative product parameters, such as a prescribed lack of defects, may be more easily detected after such aftertreatment.

The observation that the computational relationship of the process model extends to the derivative product parameters means that the derivative product parameters may be considered by the process model in principally the same way as the other quantities for which the process model describes the computational relationship.

In principle, a single derivative physical product may be produced from a single precursor charge in the method according to the invention. Yet in a further preferred embodiment of the invention, a series of successive charges of derivative physical products are produced through the derivative physical production process from a series of respective precursor charges of precursor material. Here it is preferred that the analysis system uses data input to the process model from production of the series of successive charges to update the process model. In this way, not only the derivative process settings, but also the process model itself can be improved.

According to a preferred embodiment of the invention, the updated derivative process settings are applied to a derivative physical production process for a subsequent derivative physical product from a subsequent precursor charge. Thus, also the following production of a derivative physical product may benefit from the information derives from a previous production. As noted, the updated derivative process settings may be provided based on the data input for the production of more than one derivative physical product.

According to a further preferred embodiment of the invention, based on the input to the process model by the analysis system, the analysis system provides updated precursor production settings and that the updated precursor production settings are applied to the precursor production process. In analogy to the above observations with respect to the updated derivative process settings, the updated precursor production settings may either be applied to the precursor production process for a current precursor charge and may also be applied to the precursor production process for a subsequent precursor charge. Moreover, the updated precursor production settings may also be based on further information. Conversely, the updated precursor production settings may not depend on all quantities input to the process model. Thus, the quality of the derivative physical product may be improved—or the risk of defects reduced—by means of adjustments in the production of the precursor charge.

A preferred embodiment of the invention is characterized in that, based on the input to the process model by the analysis system, the analysis system determines a precursor suitability information regarding that precursor charge for matching the derivative product specifications. In other words, it may be determined that a particular precursor charge is unsuitable, in particular with a certain probability, with respect to achieving the derivative product specifications. Such a precursor charge may then be removed from the derivative physical production process for these particular derivative product specifications and potentially reinserted in the derivative physical production process for different derivative product specifications.

A further preferred embodiment of the invention is characterized in that, based on the input to the process model by the analysis system, the analysis system determines a defect risk of the derivative physical product from the precursor charge. Such a defect risk may provide either a quantitative or a qualitative information about the derivative physical product being defective. In principle, such defect risk provided may be used in an arbitrary way. In order to facilitate an automatic supervision of the derivative physical product process, it is preferred, that the analysis system outputs a defect signal if the determined defect risk exceeds a predetermined defect risk threshold.

The above defect risk may in principle be determined at any time during the derivative physical production process or the precursor production process. In a preferred embodiment of the invention, the defect risk of the derivative physical product from the precursor charge is determined prior to completion, in particular prior to the start, of the derivative physical production process of the derivative physical product from that precursor charge. Thus, the derivative physical production process may be appropriately modified or even stopped in time before the effect of a potentially high defect risk is materialized. Here it is further preferred that the defect signal is output prior to completion, in particular prior to the start, of the derivative physical production process of the derivative physical product from that precursor charge.

In principle, the quantities measured by the analysis system may be just single values. In a further preferred embodiment of the invention, the analysis system measures a course of derivative process parameters and/or a course of the precursor process parameters and/or a course of the precursor product parameters substantially continuously during a respective measurement period of the derivative process parameters and/or the precursor process parameters and/or the precursor product parameters. In other words, the analysis system measures a substantially continuous series in time of these quantities, thereby obtaining information about dynamic behavior of these quantities, which in turn permits more precise computations by the process model. Alternatively or in addition, it may be that the analysis system measures a course of derivative product parameters substantially continuously during a respective measurement period of the derivative product parameters.

In principle, the derivative physical production process may substantially be an arbitrary physical production process. In a preferred embodiment of the invention, the derivative physical production process is a polymer molding process.

Such a polymer molding process is a molding process using thermoplastic polymer material. Thus, it is also preferred that the precursor material is a thermoplastic polymer material. According to a further preferred embodiment of the invention, the derivative physical production process is an injection molding process, the derivative physical product is an injection molded product and the precursor charge is a preferably granular polymer charge for injection molding. In particular, the thermoplastic polymer material may comprise a polycarbonate material. Then, the polymer charge may comprise polycarbonate material. The polymer charge may also be a polycarbonate charge consisting of polycarbonate material. Further, the thermoplastic polymer material, and therefore also the polymer charge, may alternatively or in addition comprise acrylonitrile butadiene styrene and/or acrylonitrile styrene acrylate.

Further it is preferred that the polymer charge comprises thermoplastic pellets. Preferably, the derivative process settings comprise cylinder temperature, injection pressure, injection speed, hold pressure, hold pressure time, dosing speed, screw speed, dosing time, backpressure, cooling time and/or cycle time. In particular, each such derivative process setting may be for an injection molding machine for the derivative physical production process. The derivative process parameters preferably comprise cavity pressure, cavity temperature, hot-channel temperature, cooling water temperature, cooling water flow rate, switching injection pressure, remaining material in screw and/or injection time. Here also, each such derivative process parameter may be from an injection molding machine or a peripheral apparatus thereof for the derivative physical production process. The derivative product parameters preferably comprise product dimensions, product shrinkage, product weight, residual moisture, viscosity, impact strength, tensile strength, stress-strain curve, surface defects, sink marks and/or degree of incomplete filling.

It may be that the precursor charge itself is produced from a starting material which may also be subject to consideration by the analysis system. Thus according to a further preferred embodiment of the invention, the precursor charge is produced through a precursor production process from a starting material, preferably from the starting material and at least one additive.

A preferred embodiment of the invention is characterized in that the analysis system measures starting material parameters from the starting material, that the computational relationship of the process model extends to the starting material parameters and that the analysis system also enters the measured starting material parameters to the process model as input. The observation that the computational relationship of the process model extends to the starting material parameters means that the starting material parameters may be considered by the process model in principally the same way as the other quantities for which the process model describes the computational relationship. In this way, any measurable parameters from the starting material can also be considered by the process model. It is further preferred that the analysis system measures additive parameters from the at least one additive, that the computational relationship of the process model extends to the additive parameters and that the analysis system also enters the measured additive parameters to the process model as input.

In principle, the precursor production process may be any kind of production process. Preferably, the precursor production process is a physical production process. Alternatively or in addition, the precursor production process may be a chemical production process.

When, as described above, the precursor material is a thermoplastic polymer material, the precursor production process may comprise a polycondensation process for producing the thermoplastic polymer material from the starting material, preferably a polymer precursor, and preferably at least one additive. The polymer precursor may be bisphenol A and the at least one additive may comprise phosgene. Alternatively or in addition, the precursor production process may comprise compounding process for producing a granular polymer charge for injection molding from the starting material. Then preferably, the precursor production process is performed by a heated twin-screw extruder. As already indicated above, the polycondensation process and the compounding process may be performed at separate facilities which may also be distant to each other.

According to a preferred embodiment of the invention, the analysis system comprises a display apparatus visually outputting the measured derivative process parameters and/or the updated derivative process settings and/or the measured precursor process parameters and/or the measured precursor product parameters. It is preferred that the visual outputting occurs substantially in real-time. It is further preferred that the display apparatus visually outputs the measured derivative product parameters.

According to a preferred embodiment of the invention, the physical production facility comprises a facility intranet, which facility intranet comprises a computing module for performing numerical analysis with the process model. In particular, the process model may be stored within the facility intranet.

The expression “comprised by the facility intranet” means that the entity in question is communicatively coupled to the facility intranet such that it is to be considered inside the facility intranet and therefore enjoys the appropriate privileges for communication within the facility intranet. Conversely, the expression “outside the facility intranet” means that the entity in question may in principle be able to communicate with a computer within the facility intranet, but that it is not privileged in the same way as a computer within the facility intranet. The computing module may consist of dedicated computing hardware, such as a personal computer or embedded computer, with appropriate software running on that computing hardware. The computing module may consist of software only, running as a module on some computing hardware, such as a server, with different software unrelated to and separate from the computing module also running on the same computing hardware.

According a further preferred embodiment of the invention, the analysis system enters the applied derivative process settings, the measured derivative process parameters, the applied precursor production settings, the measured precursor process parameters and the measured precursor product parameters as input to the process model by providing the applied derivative process settings, the measured derivative process parameters, the applied precursor production settings, the measured precursor process parameters and the measured precursor product parameters to the computing module within the facility intranet.

A preferred embodiment of the invention is characterized in that the facility intranet prevents the applied derivative process settings and the measured derivative process parameters from being transferred outside the facility intranet and that the computing module prevents read access to the process model.

A further preferred embodiment of the invention is characterized in that the derivative physical product is produced from a plurality of precursor charges of respective precursor material, wherein each precursor charge from the plurality of precursor charges is produced at a respective precursor production facility, which respective precursor production facility is distant from the physical production facility and from the respective other precursor production facilities, through a respective precursor production process based on respective applied precursor production settings, wherein the analysis system measures respective precursor process parameters from the respective precursor production process and respective precursor product parameters from the respective precursor charge and wherein the analysis system enters the respective applied precursor production settings, the respective measured precursor process parameters and the respective measured precursor product parameters as input to the process model to obtain updated derivative process settings for matching the user-defined derivative product specifications, wherein the process model describes a computational relationship between derivative process settings, derivative process parameters, a plurality of precursor production settings, a plurality of precursor process parameters and a plurality of precursor product parameters.

The system according to the invention is for improving a physical production process and comprises a physical production facility for producing a derivative physical product through a derivative physical production process from a precursor charge of precursor material based on applied derivative process settings. The system according to the invention also comprises an analysis system for measuring derivative process parameters from the derivative physical production process and further comprises a precursor production facility for producing the precursor charge, which precursor production facility is distant from the physical production facility.

The system according to the invention preferably comprises transportation means to transport the precursor charge to the physical production facility.

In the system according to the invention, the analysis system is further configured to measure precursor process parameters from the precursor production process and to measure precursor product parameters from the precursor charge, wherein the analysis system is further configured to enter the applied derivative process settings, the measured derivative process parameters, the measured precursor process parameters and the measured precursor product parameters as input to a process model, which process model is saved in the analysis system and which process model is configured to describe a computational relationship between derivative process settings, derivative process parameters, precursor production settings, precursor process parameters and precursor product parameters, to obtain updated derivative process settings for matching user-defined derivative product specifications.

In the system according to the invention, the precursor production facility (8) is at least 50 kilometers distant from the physical production facility (2).

Preferably, the derivative process settings comprise formulation data for specifying ingredients for the derivative physical production process. Such ingredients are further ingredients other than the precursor charge. Here it is preferred that the formulation data comprises specifications of proportion, weight, temperature and/or volume of respective ingredients. Such formulation data is a process parameter of especially high relevance as concerns the outcome of the derivative physical production process.

In principle the updated derivative process settings may be determined in an arbitrary manner. A preferred embodiment of the method is characterized in that the updated derivative process settings are at least partially determined, preferably by the analysis system, based on the user-defined derivative product specifications in connection with the process model. In other words the user-defined derivative process settings are arrived at by having the analysis system apply the user-defined derivative product specification on the process model. Thus, the process model and calculation based on it form the basis for determining what derivative process settings are appropriate to obtain the user-defined derivative product specifications in the derivative physical product. In this way, a trial and error method and the associated costs are avoided.

Preferred embodiments, features and advantages of the system according to the invention correspond to those of the method according to the invention and vice versa.

Further advantageous and preferred features are discussed in the following description with respect to the FIGURES. In the following it is shown in

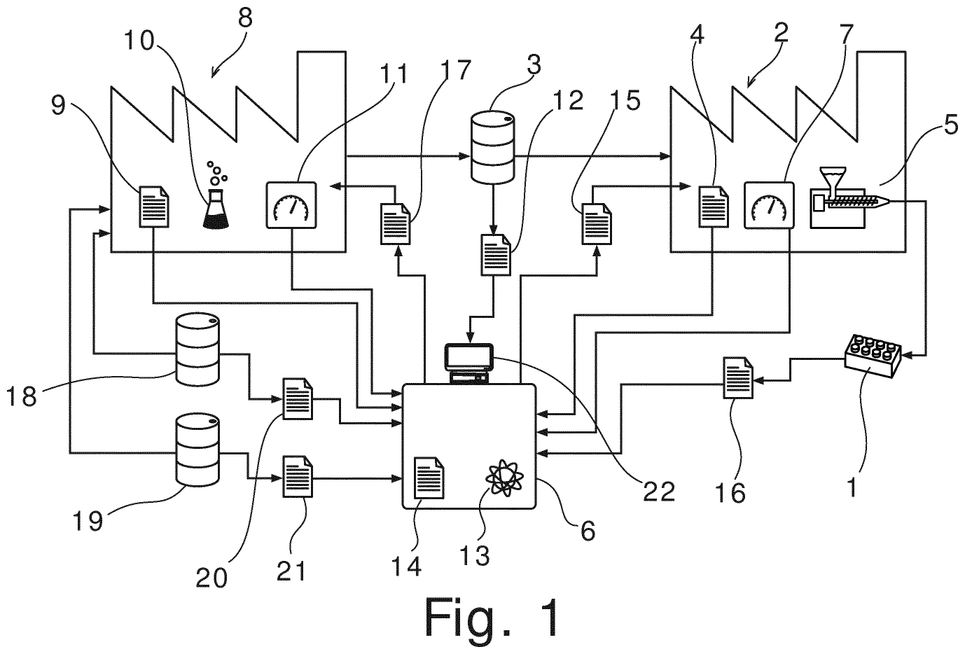

FIG. 1 a schematic view of an embodiment of the system according to the invention for carrying out the method according to the invention.

The system according to an embodiment of the invention shown in FIG. 1 concerns a physical production process and in particular a derivative physical production process for producing a derivative physical product 1 as part of a series of derivative physical products 1. In the present example, the derivative physical production process is an injection molding process, derivative physical product 1 is an injection molded product. The described system comprises a physical production facility 2 at which the derivative physical production process is executed to produce the derivative physical product 1.

At the physical production facility 2, the derivative physical product 1 is produced from a precursor charge 3 of precursor material, which in the present example is a granular polymer charge for injection molding and in particular a polycarbonate charge of polycarbonate material. For the production from that precursor charge 3, derivative process settings 4 are applied to the production and in particular to machines 5 of the physical production facility 2 for the derivative physical production process. In the present case the machines 5 may are embodied as injection molding machines as shown in FIG. 1.

The described system further comprises an analysis system 6, which in the present example is a distributed computer system, which measures derivative process parameters 7 from the derivative physical production process, e.g. from appropriate measurement instruments, in particular a plurality of sensors, of the machines 5 in the physical production facility 2. The analysis system 6 also measures derivative product parameters 16 from the derivative physical product 1 itself. The derivative product parameters 16, e.g. the dimensions of the derivative product, surface contour deviations, surface roughness or surface finish, may be measured by means of optical inspection techniques, in particular using visual light. For measuring e.g. the temperature distribution in the derivative product IR light techniques may be applied.

The described system also comprises a precursor production facility 8 which is arranged at a distance of about 100 kilometers from the physical production facility 2 at which the precursor charge 3 and in particular a series of precursor charges 3 for the production of the series of derivative physical products 1 is produced in a precursor production process from starting material 18, which is presently a polymer precursor, and further additives 19. Here, the precursor production process comprises both a polycondensation process as well as a compounding process. For the precursor production process, precursor production settings 9 are applied to precursor machines 10 in the precursor production facility 8 for producing the precursor charge 3. Each produced precursor charge 3 is transported to the physical production facility 2.

The analysis system 6 also measures precursor process parameters 11 from the precursor production process and in particular from instruments of the precursor machines 10. In addition, the analysis system 6 measures precursor product parameters 12 from the precursor charge 3, which in the present example takes place in the precursor production facility 8, starting material parameters 20 from the starting material 18 and additive parameters 21 from the additives 19.

A process model 13, which in the present example is a numerical simulation software module, is saved in the analysis system 6 along with user-defined derivative product specifications 14, which describe required parameter brackets for a set of derivative product parameters. The analysis system 6 also matches the measured derivative product parameters 16 to the user-defined derivative product specifications 14 to determine for each derivative physical product 1 whether it meets the user-defined derivative product specifications 14.

The applied derivative process settings 4, the measured derivative process parameters 7, the applied precursor production settings 9, the measured precursor process parameters 11, the measured derivative product parameters 16, the measured starting material parameters 20, the measured additive parameters 21 and the measured precursor product parameters 12 are all entered as input to the process model 13. The process model 13 is configured to process the input and establish complex computational relationships between the data that is input. Thus, based on the input it becomes possible to determine a probability for meeting the user-defined derivative product specifications 14 or for a certain defect occurring.

The measurement by the analysis system 6 proceeds continually. Thus, based on a change in the measured derivative process parameters 7, such as an increase of the temperature in a process chamber of the physical production facility 2, the applied derivative process settings 4 are adjusted by applying updated derivative process settings 15 obtained by the input entered into the process model 13. For example, the above increase in temperature may result in the adjustment of a valve to prevent a defect occurrence from the increased temperature in the ongoing derivative production process. Also, the ongoing entering of input to the process model 13 in particular with respect to the measured derivative product parameters 16 permits a successive updating of the process model 13.

It may also be that based on the measured precursor product parameters 12 and precursor suitability information determined on its basis by the analysis system 6 using the process model 13, a particular precursor charge 3 is identified as unsuitable for meeting the user-defined derivative product specifications 14 and therefore removed for this particular application to be used for a process for which the measured precursor product parameters 12 appear more suitable. The analysis system 6 may also generate a defect risk quantifying the risk of missing the user-defined derivative product specifications 14 with that precursor charge 3.

On the other hand, it may also be that any expected negative effects based on the measured precursor product parameters 12 may be compensated for by an appropriate adjustment in the updated derivative process settings 15, which may therefore be used for that particular precursor charge 3. In addition, the process model 13 may provide the analysis system 6 with updated precursor production settings 17 to be applied to the precursor production process for preventing the future occurrence of unsuitable precursor charges 3. Also, the analysis system 6 comprises a display apparatus 22 for outputting in real-time the measured derivative process parameters 7.

1.-16. (canceled)

17. Method for improving a physical production process, wherein a derivative physical product is produced at a physical production facility through a derivative physical production process from a precursor charge of precursor material based on applied derivative process settings, wherein an analysis system measures derivative process parameters from the derivative physical production process, wherein the precursor charge is produced at a precursor production facility through a precursor production process based on applied precursor production settings, wherein the analysis system measures precursor process parameters from the precursor production process and precursor product parameters from the precursor charge, wherein the analysis system enters the applied derivative process settings, the measured derivative process parameters, the applied precursor production settings, the measured precursor process parameters, the measured precursor product parameters as input to a process model, which process model describes a computational relationship between derivative process settings, derivative process parameters, precursor production settings, precursor process parameters and precursor product parameters, to obtain updated derivative process settings for matching user-defined derivative product specifications describing derivative product parameters, wherein the updated derivative process settings are applied to the derivative physical production process, characterized in that the precursor production facility is at least 50 kilometers distant from the physical production facility and that the precursor charge is transported to the physical production facility.

18. Method according to claim 17, wherein, the updated derivative process settings are applied to the derivative physical production process for the derivative physical product from the precursor charge.

19. Method according to claim 17, wherein, the analysis system measures derivative product parameters from the derivative physical product, that the analysis system matches the measured derivative product parameters to the user-defined derivative product specifications and that the analysis system also enters the measured derivative product parameters as input to the process model and that the process model extends the computational relationship to the measured derivative product parameters.

20. Method according to claim 19, wherein, derivative product parameters from the derivative physical product are measured using optical inspection techniques.

21. Method according to claim 17, wherein, a series of successive charges of derivative physical products are produced through the derivative physical production process from a series of respective precursor charges of precursor material, preferably, that the analysis system (6) uses data input to the process model from production of the series of successive charges to update the process model, in particular, that the updated derivative process settings are applied to the derivative physical production process for a subsequent derivative physical product from a subsequent precursor charge.

22. Method according to claim 17, wherein, based on the input to the process model by the analysis system, the analysis system provides updated precursor production settings and that the updated precursor production settings are applied to the precursor production process.

23. Method according to claim 17, wherein, based on the input to the process model by the analysis system, the analysis system determines a precursor suitability information regarding that precursor charge for matching the user-defined derivative product specifications.

24. Method according to claim 17, wherein, based on the input to the process model by the analysis system, the analysis system determines a defect risk of the derivative physical product from the precursor charge, that the analysis system outputs a defect signal if the determined defect risk exceeds a predetermined defect risk threshold.

25. Method according to claim 24, wherein, the defect risk of the derivative physical product from the precursor charge is determined prior to completion, in particular prior to the start, of the derivative physical production process of the derivative physical product from that precursor charge, that the defect signal is output prior to completion, in particular prior to the start, of the derivative physical production process of the derivative physical product from that precursor charge.

26. Method according to claim 17, wherein, the analysis system measures a course of derivative process parameters and/or a course of the precursor process parameters and/or a course of the precursor product parameters substantially continuously during a respective measurement period of the derivative process parameters and/or the precursor process parameters and/or the precursor product parameters, that the analysis system measures a course of derivative product parameters substantially continuously during a respective measurement period of the derivative product parameters.

27. Method according to claim 17, wherein, the derivative physical production process is an injection molding process, that the derivative physical product is an injection molded product and that the precursor charge is a granular polymer charge for injection molding.

28. Method according to claim 17, wherein the precursor charge is produced through a precursor production process from a starting material.

29. Method according to claim 28, wherein, the analysis system measures starting material parameters from the starting material, that the computational relationship of the process model extends to the starting material parameters and that the analysis system also enters the measured starting material parameters to the process model as input, that the computational relationship of the process model extends to the additive parameters and that the analysis system also enters the measured additive parameters to the process model as input.

30. Method according to claim 17, wherein, the precursor production process may comprise a compounding process for producing a granular polymer charge for injection molding from the starting material, and at least one additive, that the precursor production process is performed by a heated twin-screw extruder.

31. Method according to claim 17, wherein the analysis system comprises a display apparatus visually outputting, substantially in real-time, the measured derivative process parameters and/or the updated derivative process settings and/or the measured precursor process parameters and/or the measured precursor product parameters, that the display apparatus visually outputs the measured derivative product parameters.

32. System for improving a physical production process comprising a physical production facility for producing a derivative physical product through a derivative physical production process from a precursor charge of precursor material based on applied derivative process settings and comprising an analysis system for measuring derivative process parameters from the derivative physical production process, the system further comprising a precursor production facility for producing the precursor charge, the analysis system is further configured to measure precursor process parameters from the precursor production process and to measure precursor product parameters from the precursor charge, wherein the analysis system is further configured to enter the applied derivative process settings, the measured derivative process parameters, the measured precursor process parameters and the measured precursor product parameters as input to a process model, which process model is saved in the analysis system and which process model is configured to describe a computational relationship between derivative process settings, derivative process parameters, precursor production settings, precursor process parameters and precursor product parameters, to obtain updated derivative process settings for matching user-defined derivative product specifications, wherein the precursor production facility is at least 50 kilometers distant from the physical production facility.
